(19) United States
(12) Patent Application Publication
(10) Pub. No.: US 2008/0035170 A1
(43) Pub. Date: Feb. 14, 2008

(54) Cleaning apparatus for cleaning a chamber used in manufacturing a semiconductor device and method of cleaning a chamber by using the same

(75) Inventors: Kye-Hyun Baek, Suwon-si (KR); Jong-Hoon Kang, Suwon-si (KR); Yong-Jin Kim, Suwon-si (KR); Young-Soo Lim, Cheongju-si (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 11/878,493

(22) Filed: Jul. 25, 2007

(30) Foreign Application Priority Data
Aug. 11, 2006 (KR) 10-2006-0076025

(51) Int. Cl. B08B 6/00

(52) U.S. Cl. 134/1.1; 134/107; 134/57 R

(57) ABSTRACT

In a cleaning apparatus and a method of cleaning a chamber used in manufacturing a semiconductor device, a first plasma may be provided into a chamber to remove a first residue from an inner wall of the chamber where the first residue is attached. A second plasma may then be provided into the chamber to remove a second residue formed by the first plasma from an inside of the chamber where the second residue remains. The second residue formed by the first plasma used to clean the chamber may not pollute a semiconductor substrate located in the chamber.

### PRIORITY STATEMENT

This application claims priority under 35 USC § 119 to Korean Patent Application No. 2006-76025, filed on Aug. 11, 2006, in the Korean Intellectual Property Office (KIPO), the entire contents of which are herein incorporated by reference.

### BACKGROUND

1. Field

Example embodiments relate to a cleaning apparatus for cleaning a chamber used in manufacturing a semiconductor device and a method of cleaning the chamber by using the cleaning apparatus. Other example embodiments relate to a cleaning apparatus for cleaning a chamber used in manufacturing a semiconductor device by using plasma and a method of cleaning the chamber by using the cleaning apparatus.

2. Description of the Related Art

Technologies required to manufacture semiconductor devices have been developed to achieve required characteristics (e.g., a degree of integration, reliability and a response speed) capable of meeting needs of a changing trend in the industry. Various processes, e.g., a photolithography process, a deposition process, an etching process, a polishing process, a cleaning process and/or an inspection process, may be repeatedly performed to manufacture the semiconductor device.

The etching process and the deposition process may be performed at a relatively high temperature so that fine patterns included in the semiconductor device may deteriorate. The deterioration of the fine patterns included in the semiconductor device may cause the reliability of the semiconductor device to decrease. Thus, plasma, referred to as a fourth state of material, may be employed to manufacture a semiconductor device having a design rule of under about 90 nm.

However, when the plasma is employed, a residue formed by the plasma may be attached to an inner wall of a chamber. The amount of residue may continuously increase while a process employing the plasma is performed. The residue may be separated from the inner wall of the chamber so that the residue may pollute a semiconductor substrate located in the chamber. The residue may generate an undesired effect in subsequent processes. For example, the time required for detecting completion of a plasma etching process may be longer. A profile of a pattern formed on the semiconductor substrate may be deteriorated.

To prevent or reduce the above problems, the chamber may be cleaned to remove the residue from the inner wall of the chamber. The chamber may be effectively cleaned using plasma generated with an active gas having a relatively high reactivity. The method of cleaning the chamber may be referred to as a plasma cleaning. However, plasma used in the plasma cleaning may have relatively high reactivity. Thus, some ingredient of the plasma that is not reacted with the residue may be attached to the inner wall of the chamber. The ingredient of the plasma that is not reacted with the residue may be reacted with a film formed on the semiconductor substrate so that another residue may be formed.

### SUMMARY

Example embodiments provide a cleaning apparatus capable of effectively removing a residue formed by a plasma cleaning process performed to remove a byproduct attached to an inner wall of a chamber. Other example embodiments provide a method of cleaning a chamber used in manufacturing a semiconductor device by using the above cleaning apparatus.

In accordance with example embodiments, a cleaning apparatus for cleaning a chamber may include a first plasma providing part and a second plasma providing part. The first plasma providing part may provide first plasma into the chamber to remove a first residue from an inner wall of the chamber where the first residue is attached. The second plasma providing part may provide second plasma into the chamber to remove a second residue formed by the first plasma from an inside of the chamber where the second residue remains.

The cleaning apparatus may further include an upper electrode and a lower electrode provided in the chamber to generate the first plasma and the second plasma. Thus, the first plasma and the second plasma may be generated using the upper electrode and the lower electrode, respectively. Alternatively, the cleaning apparatus may further include a remote plasma generator connected to the chamber to generate the first plasma and the second plasma. Thus, the first plasma and the second plasma may be generated using the remote plasma generator.

The cleaning apparatus may further include an analyzing part analyzing compositions of the first plasma and the second plasma provided into the chamber. Also, the cleaning apparatus may further include a control part connected to the analyzing part, the first plasma providing part and the second plasma providing part. The control part may adjust the supply of the first plasma and the second plasma by controlling the first plasma providing part and the second plasma providing part based on a result analyzed by the analyzing part.

In accordance with example embodiments, there is provided a method of cleaning a chamber. In the method, a first plasma may be provided into a chamber to remove a first residue from an inner wall of the chamber where the first residue is attached. A second plasma may then be provided into the chamber to remove a second residue formed by the first plasma from an inside of the chamber where the second residue remains.

When a gas for generating the first plasma includes fluorine, a gas for generating the second plasma may include chlorine. When a gas for generating the first plasma includes chlorine, a gas for generating the second plasma may include fluorine. As one alternative, when a gas for generating the first plasma includes oxygen, a gas for generating the second plasma may include carbon. As another alternative, when a gas for generating the first plasma includes carbon fluoride, a gas for generating the second plasma may include chlorine and/or oxygen.

The first plasma and the second plasma may be generated inside the chamber. The amount of second residue removed by the second plasma may be in inverse proportion to a pressure of the chamber and substantially in proportion to a voltage applied to the inside of the chamber. The first plasma removing the first residue may be generated using a carbon tetrafluoride gas at a pressure of about 15 mTorr to about 35 mTorr. The first plasma may be generated using a source voltage of about 500 W to about 900 W and a bias voltage of under about 50 W. The second plasma removing the second residue may be generated using an oxygen gas at a pressure of about 15 mTorr to about 35 mTorr. The second plasma may be generated using a source voltage of about 900 W to about 1500 W and a bias voltage of under about 50 W.

In the above method of cleaning the chamber, whether the second residue generated by the first plasma remains in the chamber or not may be determined by performing a plasma analysis. When the remaining amount of the second residue is determined to be less than a predetermined or given amount by using a result obtained from the plasma analysis, a supply of the second plasma may be discontinued. When the remaining amount of the second residue is determined to be no less than the predetermined or given amount by using the result obtained from the plasma analysis, the second plasma may be continuously provided. The plasma analysis may be performed using an optical emission spectrometer or a residue gas analyzer.

In example embodiments, the first plasma and the second plasma may be generated outside the chamber and the first plasma and the second plasma are then provided in the chamber. According to example embodiments, a residue remaining in a chamber after a plasma cleaning process is performed to remove a byproduct generated by a predetermined or given process for manufacturing a semiconductor device may be clearly removed from the chamber. Thus, defects due to the residue may not be generated by subsequent processes.

### BRIEF DESCRIPTION OF THE DRAWINGS

Example embodiments will be more clearly understood from the following detailed description taken in conjunction with the accompanying drawings. FIGS. 1-7 represent non-limiting, example embodiments as described herein.

FIG. 1 is a schematic view illustrating a cleaning apparatus for cleaning a chamber used in manufacturing a semiconductor device in accordance with example embodiments;

FIG. 2 is a flow chart illustrating a method of cleaning a chamber used in manufacturing a semiconductor device by using the cleaning apparatus in FIG. 1;

FIG. 3 is a graph showing the removed amount of second residue with respect to the source voltage applied to an inside of the chamber when the chamber is cleaned using the cleaning apparatus in FIG. 1;

FIG. 4 is a graph showing the removed amount of second residue with respect to a pressure in a chamber when the chamber is cleaned using the cleaning apparatus in FIG. 1;

FIG. 5 is a flow chart illustrating a method of cleaning a chamber used in manufacturing a semiconductor device by using the cleaning apparatus in FIG. 1;

FIG. 6 is a schematic view illustrating a cleaning apparatus for cleaning a chamber used in manufacturing a semiconductor device in accordance with example embodiments; and

FIG. 7 is a flow chart illustrating a method of cleaning a chamber used in manufacturing a semiconductor device by using the cleaning apparatus in FIG. 6.

It should be noted that these Figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. In particular, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION OF EXAMPLE EMBODIMENTS

Example embodiments will now be described more fully hereinafter with reference to the accompanying drawings, in which example embodiments are illustrated. Example embodiments may, however, be embodied in different forms and should not be construed as limited to the embodiments set forth herein. Rather, these embodiments are provided so that this disclosure will be thorough and complete, and will fully convey the scope of example embodiments to those skilled in the art.

It will be understood that when an element or layer is referred to as being “on,” “connected to” and/or “coupled to” another element or layer, the element or layer may be directly on, connected and/or coupled to the other element or layer, or intervening elements or layers may be present. In contrast, when an element is referred to as being “directly on,” “directly connected to” and/or “directly coupled to” another element or layer, no intervening elements or layers are present.

It will also be understood that, although the terms “first,” “second,” etc., may be used herein to describe various elements, components, regions, layers and/or sections, these elements, components, regions, layers and/or sections should not be limited by these terms. Rather, these terms are used merely as a convenience to distinguish one element, component, region, layer and/or section from another element, component, region, layer and/or section. For example, a first element, component, region, layer and/or section could be termed a second element, component, region, layer and/or section without departing from the teachings of example embodiments.

Spatially relative terms, such as “beneath,” “below,” “lower,” “above,” “upper” and the like, may be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, when the device in the figures is turned over, elements described as below and/or beneath other elements or features would then be oriented above the other elements or features. The device may be otherwise oriented (rotated 90 degrees or at other orientations) and the spatially relative descriptors used herein interpreted accordingly.

The terminology used herein is for the purpose of describing particular embodiments only and is not intended to limit example embodiments. As used herein, the singular terms “a,” “an” and “the” are intended to include the plural forms as well, unless the context clearly indicates otherwise. It will be further understood that the terms “includes” and “including” specify the presence of stated features, integers, steps, operations, elements, and/or components, but do not preclude the presence and/or addition of one or more other features, integers, steps, operations, elements, components, and/or groups thereof.

As used herein, the expressions “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” includes the following meanings: A alone; B alone; C alone; both A and B together; both A and C together; both B and C together; and all three of A, B, and C together. Further, these expressions are open-ended, unless expressly designated to the contrary by their combination with the term “consisting of.” For example, the expression “at least one of A, B, and C” may also include a fourth member, whereas the expression “at least one selected from the group consisting of A, B, and C” does not.

As used herein, the expression “or” is not an “exclusive or” unless it is used in conjunction with the phrase “either.” For example, the expression “A, B, or C” includes A alone; B alone; C alone; both A and B together; both A and C together; both B and C together; and all three of A, B and, C together, whereas the expression “either A, B, or C” means one of A alone, B alone, and C alone, and does not mean any of both A and B together; both A and C together; both B and C together; and all three of A, B and C together.

Unless otherwise defined, all terms (including technical and scientific terms) used herein may have the same meaning as what is commonly understood by one of ordinary skill in the art. It will be further understood that terms, such as those defined in commonly used dictionaries, should be interpreted as having a meaning that is consistent with their meaning in the context of this specification and the relevant art and will not be interpreted in an idealized and/or overly formal sense unless expressly so defined herein.

Example embodiments may be described with reference to cross-sectional illustrations, which are schematic illustrations of example embodiments. As such, variations from the shapes of the illustrations, as a result, for example, of manufacturing techniques and/or tolerances, are to be expected. Thus, example embodiments should not be construed as limited to the particular shapes of regions illustrated herein, but are to include deviations in shapes that result from, e.g., manufacturing. For example, a region illustrated as a rectangle may have rounded or curved features. Thus, the regions illustrated in the figures are schematic in nature and are not intended to limit the scope of example embodiments. Like reference numerals refer to like elements throughout.

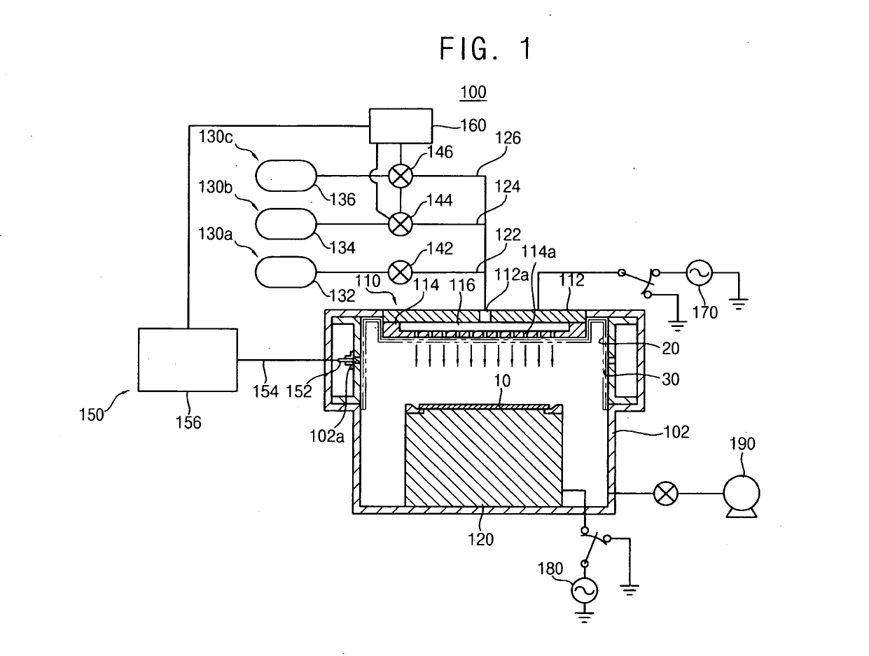

FIG. 1 is a schematic view illustrating a cleaning apparatus for cleaning a chamber used in manufacturing a semiconductor device in accordance with example embodiments. A cleaning apparatus for cleaning a chamber used in manufacturing a semiconductor device may include a first plasma providing part and a second plasma providing part. For example, the first plasma providing part may provide a chamber with first plasma to remove a first residue attached to an inner wall of the chamber. The first residue may be generated when processes are performed in manufacturing the semiconductor device. The second plasma providing part may provide the chamber with second plasma to remove a second residue remaining in the chamber. The second residue may be generated by the first plasma used in cleaning the chamber.

Referring to FIG. 1, the cleaning apparatus 100 for cleaning a chamber used in manufacturing a semiconductor device may include a chamber 102, an upper electrode 110, a lower electrode 120 and gas providing parts 130a, 130b and 130c. The upper electrode 110 and the lower electrode 120 may be located in the chamber 102. The gas providing parts 130a, 130b and 130c may provide the chamber with gases.

For example, a high frequency generating part (not illustrated) may be located in the chamber 102 to supply high frequency power to the provided gas. The high frequency power supplied to the provided gas may allow the provided gas to be in a plasma state. The high frequency generating part (not illustrated) may include the upper electrode 110, a source power generator 170, the lower electrode 120 and a bias voltage generator 180. The gas providing parts 130a, 130b and 130c may include a first gas providing part 130a providing a process gas, a second gas providing part 130b providing a gas for generating the first plasma and a third gas providing part 130c providing a gas for generating the second plasma. The first plasma providing part included in the cleaning apparatus 100 for cleaning the chamber used in manufacturing the semiconductor device may have the high frequency generating part (not illustrated) and the second gas providing part 130b. The second plasma providing part may have the high frequency generating part (not illustrated) and the third gas providing part 130c.

The upper electrode 110 may include a first electrode 112 and a second electrode 114 combined with a lower portion of the first electrode 112. The first and second electrodes 112 may have disc shapes corresponding with each other. The first electrode 112 may be disposed on an upper portion of the chamber. A source power may be applied to the first electrode 112. The upper electrode 110 may be connected to the source power generator 170 by using a first switch.

The lower electrode 120 may be located on a bottom of the chamber 102. A semiconductor substrate 10 may be supported on the lower electrode 120. The semiconductor substrate 10 may be secured on the lower electrode 120 by using a vacuum and/or an electrostatic force. The lower electrode 120 may be connected to the bias power generator 180 by using a second switch. A vacuum pump 190 may be located adjacent to the chamber 102 such that the vacuum pump 190 may communicate with a lower portion of the chamber 102.

The first gas providing part 130a may include a first gas source 132, a first line 122 and a first valve 142. The first gas source 132 may supply a process gas used to perform a predetermined or given process on a film formed on the semiconductor substrate 10. The first line 122 may connect the first gas source 132 to the chamber 102. The first valve 142 may be located on the first line 122. For example, the process gas supplied from the first gas source 132 may be provided into the chamber 102 through a supplying hole 112a of the first electrode 112 and a shower hole 114a of the second electrode 114, and then, the gas may change into plasma between the upper electrode 110 and the lower electrode 120.

The second gas providing part 130b may include a second gas source 134, a second line 124 and a second valve 144. The second gas source 134 may supply a cleaning gas that reacts with a first residue 20. The second line 124 may connect the second gas source 134 to the chamber 102. The second valve 144 may be located on the second line 124. For example, the cleaning gas supplied from the second gas source 134 may provided into the chamber 102 through the supplying hole 112a of the first electrode 112 and the shower hole 114a of the second electrode 114, and then the cleaning gas may change into the first plasma. The first plasma may then react with the first residue 20 to form a volatile reactant that is exhausted from the chamber 102.

The third gas providing part 130c may provide a counter gas to remove the second residue 30. For example, the counter gas may be a gas reacting with the second residue 30 or the first plasma without reacting with the film formed on the semiconductor substrate 10. For example, the counter gas may react with only the second residue 30 or the first plasma such that a third residue may not be generated by the counter gas.

The third gas providing part 130c may include a third gas source 136, a third line 126 and a third valve 146. The third gas source 136 may provide the counter gas. The third line 126 may connect the third gas source to the chamber 102. The third valve 146 may be located on the third line 126. For example, the counter gas supplied from the third gas source 136 may provided into the chamber 102 through the supplying hole 112a of the first electrode 112 and the shower hole 114a of the second electrode 114, and then, the counter gas may change into the second plasma between the upper electrode 110 and the lower electrode 120. The second plasma may react with the second residue 30 to form a volatile reactant that is exhausted by the vacuum pump 190.

A view port 102a and a window (not illustrated) may be formed on a side portion of the chamber 102. The view port 102a may be formed through a sidewall of the chamber 102. A window (not illustrated) transmitting light may be formed to cover the view port 102a. An analyzing part 150 connected to the view port 102a may be formed. The analyzing part 150 may analyze the transmitted light to monitor a predetermined or given process using plasma, e.g., a plasma etching process.

The analyzing part 150 may include an optical probe 152, an optical cable 154 and a plasma analyzing part 156. The optical probe 152 may be connected to the view port 102a. The optical cable 154 may be connected to the optical probe 152 and the plasma analyzing part 156. The plasma analyzing part 156 may analyze light provided through the view port 102a, the optical probe 152 and the optical cable 154. The plasma analyzing part 156 may be an optical emission (OES), a self plasma optical emission spectrometer and/or a residue gas analyzer (RGA).

When the film formed on the semiconductor substrate 10 is treated with plasma, a chemical composition of the plasma may be changed by a composition of a residue material in the chamber in which the film is located. A spectrum of a light emitted from the plasma may change due to a change in reacted material. The composition of the residue material residing in the chamber 102 may be analyzed using a variation of the spectrum of the light measured by the optical emission spectrometer.

A control part 160 connected to the optical analyzing part 150, the second valve 144 and the third valve 146 may be further formed. The control part 160 may control the first plasma providing part and the second plasma providing part based on a result analyzed by the optical analyzing part 150. For example, the control part 160 connected to the second valve 144 and the third valve 146 may control flow rates of the cleaning gas and the counter gas. A shower head 116 providing the gases toward the substrate 10 may be located over the lower electrode 120.

When the detected amount of the second residue in the chamber 102 is no less than a predetermined or given amount, the third valve 144 may be closed to stop supplying the second plasma. When the detected amount of second residue in the chamber 102 is no more than the predetermined or given amount, the counter gas may be continuously supplied into the chamber 102.

Therefore, the second residue 30 in the chamber 102 may be monitored in real time and the second residue 30 may be removed more precisely. Hereinafter, a cleaning method using a cleaning apparatus for cleaning a chamber used in manufacturing a semiconductor device will be described.

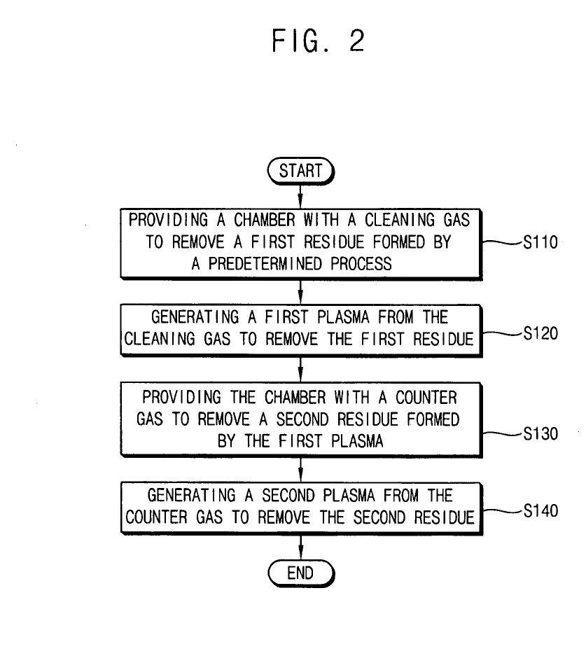

FIG. 2 is a flow chart illustrating a method of cleaning a chamber used in manufacturing a semiconductor device by using the cleaning apparatus in FIG. 1. To manufacture a semiconductor device on a semiconductor substrate, a predetermined or given process using plasma may be employed. An example of the process using the plasma may be a plasma etching process. Plasma may be generated from a process gas in a chamber when the process is performed. A film formed on the semiconductor substrate may then be reacted with the plasma.

While the process is performed, a first residue, e.g., an etch residue, may be formed. The first residue may be attached to an inner surface of the chamber. For example, when a silicon oxide (SiO₂) film formed on the semiconductor substrate is etched by a plasma etching process, the etch residue, e.g., silicon fluoride (SiFₓ), may be generated. The etch residue may be attached to the inner surface of the chamber.

Referring to FIG. 2, the first residue attached to the inner wall of the chamber may be removed by providing first plasma to the inside of the chamber. When the chamber includes a high frequency generating part, an upper electrode and a lower electrode to generate plasma, a cleaning gas may be provided into the chamber in S110. The cleaning gas may change into cleaning plasma in the chamber in S120 so that the first plasma corresponding to the cleaning plasma may be supplied to the inside of the chamber.

The cleaning gas may include fluorine (F), chlorine (Cl) and/or oxygen (O) and may have a relatively high reactivity. Alternatively, the cleaning gas may include carbon fluoride (CxFy). When the cleaning gas includes fluorine, the cleaning gas may be a sulfur hexafluoride (SF₆) gas, a nitrogen trifluoride (NF₃) gas, a hydrogen fluoride (HF) gas and/or a silicon tetrafluoride (SiF₄) gas. When the cleaning gas includes chlorine (Cl), the cleaning gas may be a chlorine (Cl₂) gas, a boron trichloride (BCl₃) gas, a carbon tetrachloride (CCl₄) gas and/or a silicon tetrachloride (SiCl₄) gas. When the cleaning gas includes oxygen (O), the cleaning gas may be an oxygen (O₂) gas and/or an ozone (O₃) gas. When the cleaning gas includes carbon fluoride (CxFy), the cleaning gas may be a carbon tetrafluoride (CF₄) gas, a hexafluoroethane (C₂F₆) gas, an octafluoropropane (C₃F₈) gas and/or a octafluorocyclobutane (C₄F₈) gas.

In S110 and S120, the first residue including silicon fluoride (SiFₓ) may be removed by the first plasma generated from the carbon tetrafluoride (CF₄) gas. For example, the carbon tetrafluoride (CF₄) gas corresponding to the cleaning gas and an argon (Ar) gas may be provided to the chamber to generate the first plasma. A plasma cleaning process may be performed at a pressure of about 15 mTorr to about 35 mTorr. A source voltage of about 500 W to about 900 W and a bias voltage of about 0 W to about 50 W may be applied to generate the first plasma. The plasma cleaning process may be performed for about 10 seconds to about 40 seconds. However, the above conditions required for performing the plasma cleaning process may change based on a volume of the chamber 102 and/or a flow rate of the cleaning gas.

While the plasma cleaning process is performed using the first plasma, the second residue including a residue formed by a reaction between the cleaning gas and the film formed on the semiconductor substrate and a residue formed by the first plasma may be formed on the inner surface of the chamber. When the plasma cleaning process is performed using the carbon fluoride (CxFy) gas, the second residue formed on the inner surface of the chamber by the first plasma may include a residue including a polymer and a residue including carbon fluoride (CxFy) that has a relatively large adhesive property.

When processes, e.g., an etching process, are continuously performed in the chamber where the second residue formed by the first plasma is attached, the second residue may undesirably affect the processes. For example, when the etching process is subsequently performed in the chamber where the second residue is attached, the second residue may form another residue on the semiconductor substrate or the second residue may react with the film on the semiconductor substrate to alter a composition of the film. Thus, an additional process may be required to remove the second residue formed on the inner surface of the chamber by the first plasma.

The second residue may be removed by providing the chamber where the second residue resides with the second plasma. The second plasma may be generated from the counter gas having reactivity with respect to the cleaning gas or the first plasma. For example, the counter gas may be provided into the chamber in S130. For example, when the cleaning gas includes chlorine (Cl), the counter gas may include fluorine (F).

On the other hand, when the cleaning gas includes fluorine (F), the counter gas may include chlorine (Cl). When the cleaning gas includes oxygen (O), the counter gas may include carbon (C). Further, when the cleaning gas includes carbon fluoride (CxFy), the counter gas may include chlorine (Cl) and/or oxygen (O). When the counter gas is reacted with the film formed on the semiconductor substrate, another residue may be formed in the chamber. Thus, the counter gas may not react with the film formed on the semiconductor substrate.

The second residue may then be removed using second plasma changed from the counter gas in S140. In S130 and S140, the counter gas used to remove the second residue including the residue formed from the polymer and the residue formed from carbon fluoride (CxFy) may have a relatively large adhesive property. For example, the oxygen (O₂) gas and the argon (Ar) gas may be provided to the chamber to generate the second plasma. A plasma cleaning process may be performed at a pressure of about 15 mTorr to about 35 mTorr. A source voltage of about 900 W to about 1500 W and a bias voltage of about 0 W to about 50 W may be applied to generate the second plasma. The plasma cleaning process may be performed for about 5 seconds to about 20 seconds. However, the above conditions required for performing the plasma cleaning process may change based on a volume of the chamber 102 and/or a flow rate of the counter gas.

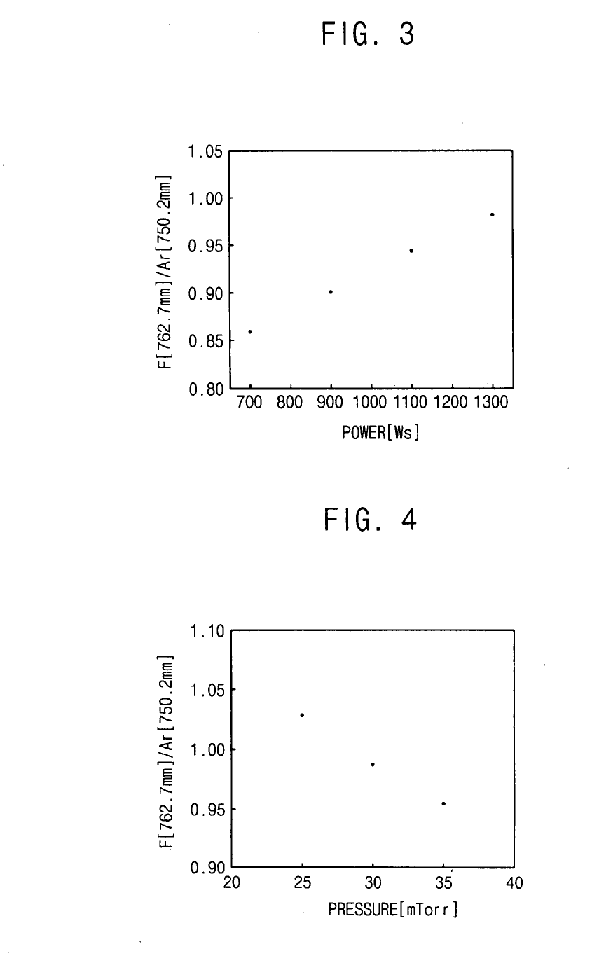

FIG. 3 is a graph showing the removed amount of second residue with respect to the source voltage applied to an inside of the chamber when the chamber is cleaned using the cleaning apparatus in FIG. 1. Referring to FIG. 3, the removed amount of second residue measured when the second residue including carbon fluoride (CxFy) is removed using the second plasma generated by the argon (Ar) gas may be illustrated as a function of the source voltage (Ws) applied to the upper electrode of the chamber. The removed amount of second residue may be calculated using a ratio of fluorine to argon (F/Ar) detected from a residue gas exhausted from the chamber.

As illustrated in FIG. 3, when the source voltage is about 700 W, the ratio of fluorine to argon (F/Ar) may be about 0.86. When the source voltage is about 1100 W, the ratio of fluorine to argon (F/Ar) may be about 0.95. When the source voltage is about 1300 W, the ratio of fluorine to argon (F/Ar) may be about 0.98. Accordingly, the removed amount of second residue may be substantially in proportion to the applied source voltage.

FIG. 4 is a graph showing the removed amount of second residue with respect to a pressure in a chamber when the chamber is cleaned using the cleaning apparatus in FIG. 1. Referring to FIG. 4, the removed amount of second residue measured when the second residue including carbon fluoride (CxFy) is removed using the second plasma generated by the argon (Ar) gas under the same condition as the experiment in FIG. 3 may be illustrated as a function of the source voltage (Ws) applied to the upper electrode of the chamber. The removed amount of second residue may be calculated using a ratio of fluorine to argon (F/Ar) detected from a residue gas exhausted from the chamber.

As illustrated in FIG. 4, when the pressure of the chamber is about 25 mTorr, the ratio of fluorine to argon may be about 1.03. When the pressure of the chamber is about 30 mTorr, the ratio of fluorine to argon (F/Ar) may be about 0.99. When the pressure of the chamber is about 35 mTorr, the ratio of fluorine to argon (F/Ar) may be about 0.95. Accordingly, the removed amount of second residue may be substantially in inverse proportion to the pressure of the chamber.

In the cleaning process using the second plasma, the removed amount of second residue may be in proportion to the applied voltage. On the other hand, the removed amount of second residue may be in inverse proportion to the pressure of the chamber. The oxygen (O₂) gas may not affect a subsequent etching process performed on the silicon oxide (SiO₂) layer formed on the semiconductor substrate because the oxygen (O₂) gas used to generate the second plasma may have a relatively small reactivity with the silicon oxide layer formed on the semiconductor substrate. As described above, the plasma cleaning process and a process of removing the second residue formed by the plasma cleaning process may be subsequently performed. Thus, the second residue may be efficiently removed without affecting subsequent processes required for manufacturing the semiconductor substrate.

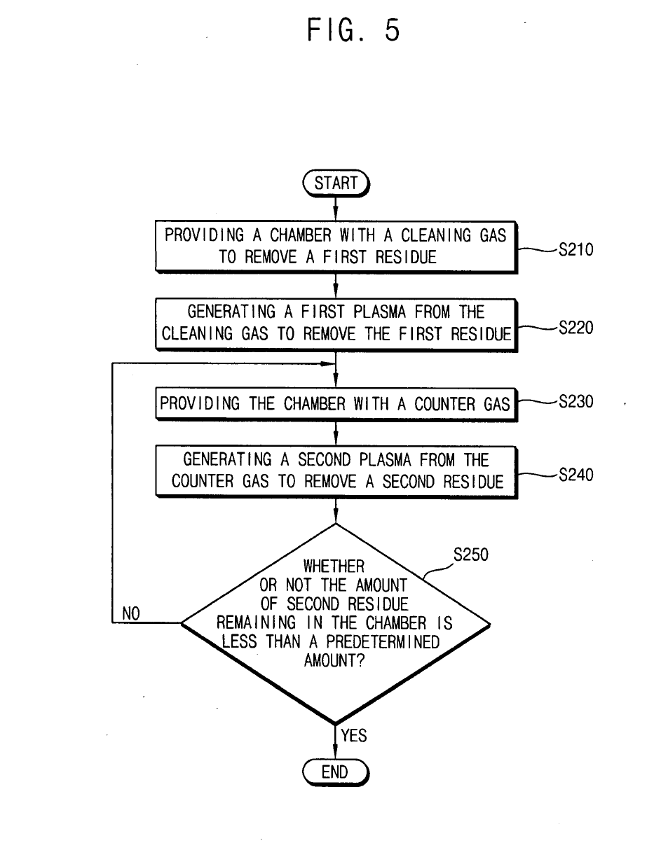

FIG. 5 is a flow chart illustrating a method of cleaning a chamber used in manufacturing a semiconductor device by using the cleaning apparatus in FIG. 1. Referring to FIG. 5, a cleaning gas may be provided to a chamber where a first residue formed by a process performed on a semiconductor substrate is attached in S210. The first residue may be removed by generating first plasma from the cleaning gas in S220. A counter gas may then be provided into the chamber to remove a second residue formed by the first plasma in S230. The second residue may be removed by generating second plasma from the counter gas in S240. Processes in 210 to 240 are substantially the same as or similar to those illustrated in FIGS. 2 to 4. Thus, any redundant explanation is omitted.

Whether the second residue remains in the chamber or not is determined by performing a plasma analysis to the chamber in S250. When the detected amount of second residue remaining in the chamber is less than a predetermined or given amount, a supply of the second plasma may be discontinued. The cleaning process may then be completed.

However, when the detected amount of second residue remaining in the chamber is no less than the predetermined or given amount, the processes in S230 to S250 may be performed again to allow the second plasma to be continuously provided. Thus, the second residue remaining in the chamber may be continuously removed. For example, the processes in S230 to S250 may be repeatedly performed to reduce the amount of second residue remaining in the chamber under the predetermined or given amount.

For example, the amount of second residue in the chamber may be reduced under the predetermined or given amount by continuously providing the second plasma into the chamber with monitoring the amount of second residue by using a plasma analysis. As described above, the second plasma may be generated in the chamber to clean the chamber. Alternatively, the second plasma may be generated outside the chamber. The second plasma may then be introduced into the chamber to clean the chamber.

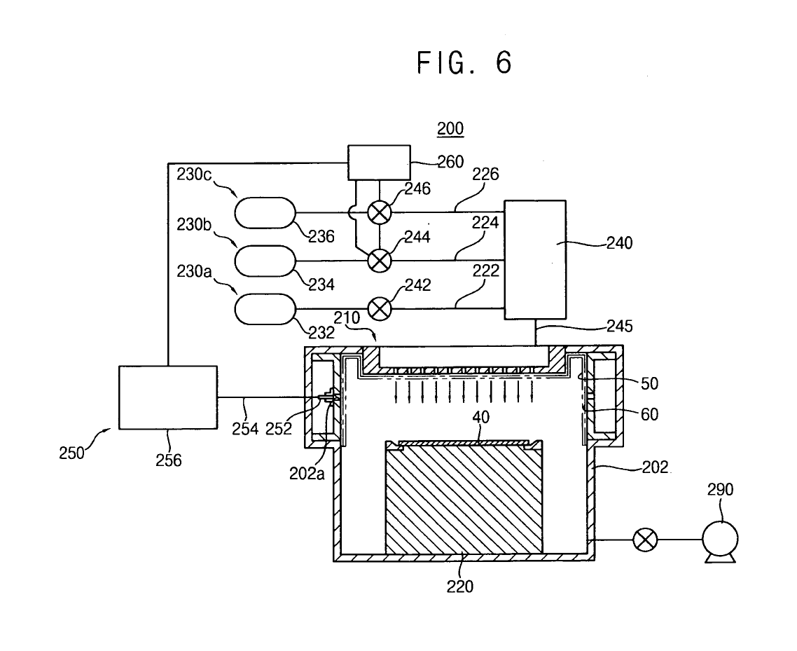

FIG. 6 is a schematic view illustrating a cleaning apparatus for cleaning a chamber used in manufacturing a semiconductor device in accordance with example embodiments. Referring to FIG. 6, the cleaning apparatus 200 for cleaning a chamber used in manufacturing a semiconductor device may include a chamber 202, a remote plasma generator 240, a first gas providing part 230a, a second gas providing part 230b and a third gas providing part 230c, an analyzing part 250 and a control part 260. The remote plasma generator 240 may be connected to the chamber 202. The remote plasma generator 240 may generate plasma from the outside of the chamber 202 and then provide the plasma into the chamber 202. The first, second and third gas providing parts 230a, 230b and 230c may provide the remote plasma generator 240 with gases. The analyzing part 250 may be connected to the chamber 202. The control part 260 may control gas supplies of the second and third gas providing parts 230b and 230c based on a result analyzed by the analyzing part 250.

For example, a stage 220 supporting a semiconductor substrate 40 may be located at a lower portion of the chamber 202. A shower head 210 providing the gases toward the substrate 40 may be located over the stage 220. A vacuum pump 290 may be connected to a side portion of the chamber 202.

The remote plasma generator 240 may be connected to the first, second and third gas providing parts 230a, 230b and 230c providing a process gas, a cleaning gas and a counter gas, respectively. The remote plasma generator 240 may be connected to the first, second and third gas providing parts 230a, 230b and 230c through first, second and third lines 222, 224 and 226, respectively. First, second and third valves 242, 244 and 246 may be provided on the first, second and third lines 222, 224 and 226, respectively. A connecting pipe 245 may connect the remote plasma generator 240 to the chamber 202.

The remote plasma generator 240 may be connected to a high frequency generating part (not illustrated) to apply a high frequency to the process gas, the cleaning gas and the counter gas provided into the remote plasma generator 240. The high frequency may transform the process gas, the cleaning gas and the counter gas into process plasma, first plasma and second plasma, respectively. Thus, the first, second and third gas providing parts 230a, 230b and 230c together with the remote plasma generator 240 may serve as first, second and third plasma providing parts, respectively.

A view port 202a and a window (not illustrated) transmitting a light may be formed on another side portion of the chamber 202. The view port 202a may be connected to an analyzing part 250 analyzing a composition of plasma in the chamber 202 in real time. For example, the analyzing part 250 may include an optical probe 252, an optical cable 254 and a plasma analyzing part 256. The plasma analyzing part 256 may analyze a light provided through the view port 202a, the optical probe 252 and the optical cable 254.

The analyzing part 250, a second valve 244 and a third valve 246 may be connected to the control part 260. For example, a result analyzed by the analyzing part 250 may be provided to the control part 260. The control part 260 may open and close the second valve 244 based on the analyzed result to control a flow rate of the cleaning gas. The control part 260 may open and close the third valve 246 based on the analyzed result to control a flow rate of the counter gas.

The above cleaning apparatus 200 may provide the first plasma into the chamber 202 using the remote plasma generator 240 to remove the first residue 50 attached to the chamber. When the second residue 60 is formed by the first plasma, the apparatus 200 may provide the second plasma into the chamber 202 to remove the second residue 60 from the chamber 202.

Accordingly, reliabilities of subsequent processes performed to manufacture the semiconductor device may increase because the second residue 60 formed by the first plasma is clearly removed from the chamber 202. Hereinafter, a cleaning method using the cleaning apparatus 200 for cleaning the chamber 202 used to manufacture the semiconductor device will be described.

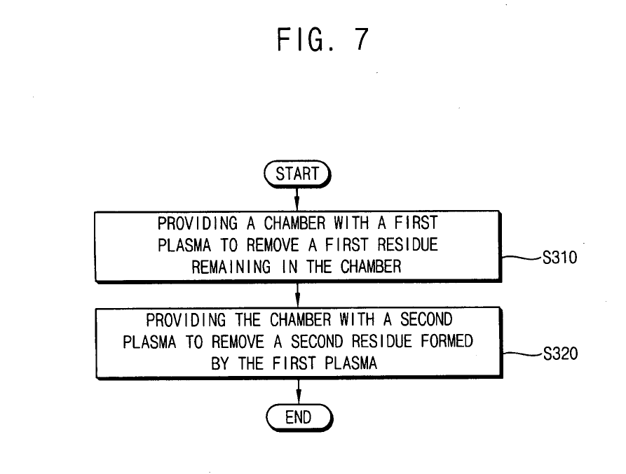

FIG. 7 is a flow chart illustrating a method of cleaning a chamber used in manufacturing a semiconductor device by using the cleaning apparatus in FIG. 6. Referring to FIG. 7, a first residue, formed by a predetermined or given process performed on a semiconductor substrate, may be removed from an inner wall of a chamber by providing first plasma into the chamber in S310. The first plasma may be provided from a remote plasma generator located outside the chamber. For example, the first plasma may decompose the first residue into a volatile material so that the volatile material may be exhausted from the chamber. Alternatively, the first residue may be detached from the inner wall of the chamber, and then, the detached first residue may then be exhausted from the chamber.

As described above, a second residue may be generated by the first plasma. Accordingly, the second residue may be removed by providing second plasma generated from the counter gas into the chamber in S320. The second plasma may be generated outside the chamber by the remote plasma generator. The second plasma may then be provided into the chamber.

Although not illustrated in the drawings, steps illustrated in FIG. 5 may be performed. For example, whether the second residue remains in the chamber or not may be determined. When the amount of second residue remaining in the chamber is less than a predetermined or given amount, a supply of the second plasma may be discontinued. When the amount of second residue remaining in the chamber is no less than the predetermined or given amount, the second plasma may be continuously provided.

As described above, the second residue, formed by the first plasma employed to clean the chamber, may be removed from the chamber. Thus, a particle, due to the second residue, may not be formed in the chamber while subsequent processes are performed to manufacture the semiconductor device. The second residue may not be reacted with a film formed on the semiconductor substrate so that a composition of the film may not change.

According to example embodiments, a residue that remains in a chamber, after a plasma cleaning process is performed to remove a byproduct generated by a predetermined or given process for manufacturing a semiconductor device, may be clearly removed from the chamber. Thus, defects due to the residue may not be generated by subsequent processes. As a result, a reliability of the semiconductor device may increase. A period of a preventive or protective maintenance step performed to clean the chamber of the cleaning apparatus may increase. Thus, a working ratio of the cleaning apparatus may increase.

The foregoing is illustrative of example embodiments and is not to be construed as limiting thereof. Although a few example embodiments have been described, those skilled in the art will readily appreciate that many modifications are possible in the embodiments without materially departing from the novel teachings and advantages of example embodiments. Accordingly, all such modifications are intended to be included within the scope of example embodiments as defined in the claims. Therefore, it is to be understood that the foregoing is illustrative of example embodiments and is not to be construed as limited to the specific embodiments disclosed, and that modifications to the disclosed embodiments, as well as other embodiments, are intended to be included within the scope of the appended claims. Example embodiments are defined by the following claims, with equivalents of the claims to be included therein.

What is claimed is:

1. A cleaning apparatus for cleaning a chamber comprising:
a first plasma providing part providing a first plasma into the chamber to remove a first residue from an inner wall of the chamber where the first residue is attached; and
a second plasma providing part providing second plasma into the chamber to remove a second residue formed by the first plasma from an inside of the chamber where the second residue remains.

2. The cleaning apparatus of claim 1, further comprising:
an upper electrode and a lower electrode in the chamber to generate the first plasma and the second plasma, respectively.

3. The cleaning apparatus of claim 1, further comprising:
a remote plasma generator connected to the chamber to generate the first plasma and the second plasma.

4. The cleaning apparatus of claim 1, further comprising:
an analyzing part analyzing compositions of the first plasma and the second plasma provided to the chamber; and
a control part connected to the analyzing part, the first plasma providing part and the second plasma providing part to adjust the supply of the first plasma and the second plasma by controlling the first plasma providing part and the second plasma providing part based on a result analyzed by the analyzing part.

5. A method of cleaning a chamber comprising:
providing a first plasma into a chamber to remove a first residue from an inner wall of the chamber where the first residue is attached; and
providing a second plasma into the chamber to remove a second residue formed by the first plasma from an inside of the chamber where the second residue remains.

6. The method of claim 5, wherein the first plasma and the second plasma are generated in the chamber.

7. The method of claim 5, wherein the first plasma and the second plasma are generated outside the chamber and the first plasma and the second plasma are then provided in the chamber.

8. The method of claim 5, wherein a gas for generating the first plasma and a gas for generating the second plasma include fluorine and chlorine, respectively.

9. The method of claim 5, wherein a gas for generating the first plasma and a gas for generating the second plasma include chlorine and fluorine, respectively.

10. The method of claim 5, wherein a gas for generating the first plasma and a gas for generating the second plasma include oxygen and carbon, respectively.

11. The method of claim 5, wherein a gas for generating the first plasma includes carbon fluoride and a gas for generating the second plasma includes chlorine and/or oxygen.

12. The method of claim 6, wherein the amount of second residue removed by the second plasma is in inverse proportion to a pressure of the chamber and substantially in proportion to a voltage applied to an inside of the chamber.

13. The method of claim 6, wherein the first plasma removing the first residue is generated using a carbon tetrafluoride gas at a pressure of about 15 mTorr to about 35 mTorr and the first plasma is generated using a source voltage of about 500 W to about 900 W and a bias voltage of under about 50 W.

14. The method of claim 6, wherein the second plasma removing the second residue is generated using an oxygen gas at a pressure of about 15 mTorr to about 35 mTorr and the second plasma is generated using a source voltage of about 900 W to about 1500 W and a bias voltage of under about 50 W.

15. The method of claim 5, further comprising:
determining whether the second residue generated by the first plasma remains in the chamber or not by performing a plasma analysis; and
discontinuing a supply of the second plasma when the remaining amount of the second residue is determined to be less than a predetermined or given amount by using a result obtained from the plasma analysis; and
continuously providing the second plasma when the remaining amount of the second residue is determined to be no less than the predetermined or given amount by using the result obtained from the plasma analysis.

16. The method of claim 15, wherein the plasma analysis is performed using an optical emission spectrometer or a residue gas analyzer.
